(19) United States
(12) Patent Application Publication
(10) Pub. No.: US 2008/0246712 A1
(43) Pub. Date: Oct. 9, 2008

(54) Programmable Gray Level Generation Unit

(75) Inventors: Pier L. Cavallini, Swindon (GB); Echart Rzittka, Wildberg (DE); Sascha Hegwein, Berlin (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/814,279

(22) PCT Filed: Jan. 13, 2006
(86) PCT No.: PCT/IB2006/050132

§ 371 Date: Jun. 13, 2008

(30) Foreign Application Priority Data
Jan. 18, 2005 (EP) 05100266.5

(51) Int. Cl. G09G 3/36

(52) U.S. Cl. 345/89

(57) ABSTRACT

The invention relates to a circuit arrangement (12) for providing voltages for generation of different gray levels in a display device (11). It further relates to a display device (11) applying such circuit arrangement (12). The invention further relates to a method for providing different gray level curves (33-36) representing different voltage characteristics supplied to a display device (11). To provide a circuit arrangement (12) and a method which are able to generate a wide range of gray level curves (33-36) a circuit arrangement (12) is proposed including a first voltage unit (21); a second voltage divider unit (22) having a plurality of tap points (x); at least one amplifying unit (24, 25) coupled between the first voltage unit (21) and the second voltage divider unit (21, 22), wherein at least one programmable current source (26, 27, 28, 29) is provided for injecting a current (Imain) into a tap point (x) of the second voltage divider unit (22). Using the inventive circuit arrangement may avoid a re-design of the masks for the chip producing process if the circuit arrangement is used for a different display device (11) or under different conditions.

The invention relates to a circuit arrangement for providing voltages for generation of different gray levels in a display device. It further relates to a display device applying such circuit arrangement. The invention further relates to a method for providing different gray level curves representing different voltage characteristics supplied to a display device.

The display technique will play an increasingly important role in the information and communication technique in the years to come. Being an interface between humans and the digital world, the display device is of crucial importance for the acceptance of contemporary information systems. Notably portable apparatus such as, for example, notebooks, telephones, digital cameras and personal digital assistants may not be realized without utilizing displays.

In general there are different kinds of displays. An important part is represented by liquid crystal display (LCD) consisting of a number of substrates. Such LC-display is subdivided in the form of a matrix of rows and columns. There are row electrodes and column electrodes arranged on respective substrates, wherein the electrodes form a grid. A layer with liquid crystals is provided between said substrates. The intersections of these electrodes define pixels. The electrodes are supplied with voltages that orient the liquid crystal molecules of the driven pixels in an appropriate direction so that the driven pixel appears in a different brightness depending on the reflected light or the backlight.

The two kinds of LC display arrangements are passive matrix displays and active matrix displays. The passive matrix LCD technology is a very commonly used display technology; it is used, for example in PDA's and in mobile telephones. Passive matrix displays are usually based on the (S)TN (Super Twisted Nematic) effect.

The active matrix displays also called Thin Film Transistor (TFT) displays using a switching element within each pixel, which is commonly realized as a thin film transistor.

Additionally there are other kinds of display technologies, e.g. organic light emitting diodes (OLED), polymer light emitting diodes (PLED) or low temperature poly-silicons (LTPS) also having rows and columns arranged in matrix form.

The most kinds of display devices using a gray level voltage generation circuit for providing a plurality of different voltages for different gray levels. These different gray level voltages are selected in dependency of the data to be displayed at a certain pixel of the display device.

A most common circuit arrangement for providing different voltages for gray levels is using a resistor ladder for providing a plurality of different partial voltages. Using a resistor ladder has a disadvantage in terms of flexibility because if a new set of gray levels is needed for a display device all taps of the resistor ladder needs to be moved. This will require a costly re-design of the circuit arrangement.

A further possibility is to use a voltage multiplexing approach, wherein the flexibility is also limited by the choice of the multiplexed voltage values and the complexity of the algorithm for the programming of the multiplexers.

A reference voltage generation circuit is disclosed in the US 2002/0186231. This reference voltage generation circuit uses two resistor ladders to provide different partial voltages. Further there are buffers for amplifying voltages provided by a first resistor ladder. It is disclosed to arrange a couple of resistor ladders, wherein a kind of multiplex switches are connected to allow a selection between different voltages. However the circuitry is very complex and limited in respect to the possibility of usability for different display panels.

Therefore it is an object of the present invention to provide a circuit arrangement and a method overcoming the mentioned problems. It is a further object to provide a circuit arrangement which is able to generate a wide range of gray level curves.

The object is solved by the features of the independent claims.

The invention bases on a thought that by using programmable current sources which are injecting or sinking a current into the second voltage divider unit the generation of a wide range of different gray level curves is possible. This will avoid to perform costly re-designs and to mask the basic design of chip depending on the application. So the circuit arrangement may be used for a wide range of different color LCD-panels only by programming of the respective current sources.

The typical gray level curve has a monotonic non-linear distribution of the voltage values from a maximum voltage to a minimum voltage. By changing the characteristic of such gray level curve the quality of displaying a gray level on the display device can be improved. Normally the gray level curve is adapted to a specific display device. But the gray level voltage generation is influenced by process parameters and by the ambient temperature. So a kind of calibration of the gray level voltage generation needs to be performed anyway. This calibration will be solved by the approaches known in the art. But the possibility to use the circuit arrangement for the gray level voltage generation for different display devices is strongly limited.

To avoid the problem of making re-designs of the masks for the chip producing process it is proposed according to the invention to arrange a first voltage unit and a second voltage divider unit having a plurality of tap points. It is further necessary to have at least one amplifying unit which is coupled between the first voltage unit and second voltage divider unit wherein at least one programmable current source is used for providing a current which is injected into a tap point within the second voltage divider unit.

One basic idea of the invention is to use two different voltage divider units which are coupled to each other. The first voltage unit provides at least the voltages used for displaying black and the white color values. An amplifying unit is used for buffering the maximum voltage and/or the minimum voltage which are feed to the second voltage divider unit. The maximum voltage is used for displaying a black color on the display, wherein the minimum voltage value is used for displaying a white color on the display.

The second voltage divider unit is connected to a programmable current source. The idea behind this concept it to shape the gray level voltage curve by sinking or sourcing a current into tap points of the second voltage divider unit. If the current source sources or sinks a certain amount of current the resulting gray level voltage on the certain tap point within the second voltage divider unit is increasing/decreasing accordingly. By using this inventive arrangement, it is possible to adapt the gray level curve without using a costly mask re-design or to use different voltage driver for different LCD-panels. The inventive arrangement using the additionally current sources may be result in a slightly increased price of the circuit arrangement. However, the possibility to use the inventive circuit arrangement for providing the gray level voltages for a wide range of different display-panels is justifying the slightly increased costs. Additionally in many cases there are current sources on a chip, which could be used instead of arranging a new current source directly for the second voltage divider unit.

In a preferred embodiment of the present invention the first voltage unit provides at least one reference voltage to the at least one amplifying unit. This embodies a very simple design, wherein only two different voltages, e.g. directly supplied by the system power supply, are applied to an amplifying unit for buffering the voltages representing the maximum and the minimum voltage for illustrating the black and the white color on the display device. It may be proposed to provide a first and a second reference voltage to the first voltage unit. The maximum voltage will be generated from the higher reference voltage and the second reference voltage will be generated from the minimum voltage used for providing the voltage for the white color.

In a further preferred embodiment of the present invention the first voltage unit is realized as voltage divider unit having a plurality of tap points. The first voltage divider unit and the second voltage divider unit are realized as resistor ladders advantageously. There is a plurality of tap points arranged within the first and the second resistor ladder between the single resistors. The tap points in the second resistor ladder are used for supplying the required different gray level voltages used for supplying these voltages to the display device.

In a preferred embodiment, it is proposed to arrange a voltage-selecting unit between the first and second voltage divider units. By using such voltage-selecting units, it is possible to adapt the minimum and the maximum voltage supplied to the second voltage divider unit. Such voltage-selecting unit may be realized as a multiplexer known as such in the art. By having the possibility to adapt the minimum and the maximum voltage it is possible to adjust these voltages depending on temperature changes or depending on different environmental conditions or process parameters.

It is advantageously proposed to provide respectively an amplifying unit for the maximum and minimum voltage between the voltage selection unit and the second voltage divider unit. By using such amplifying unit which may be realized as a buffer it is secured to provide constant maximum and minimum voltage values against different current injections performed by the current sources. Thus the maximum and minimum voltage values could not be influenced by the injection of current. The only possibility to change the maximum and minimum voltage values is to select a different voltage value by using the selecting units.

In a further preferred embodiment it is proposed to have a programmable main current source and at least one programmable partial current source. The main current source is programmed to supply a main current to the plurality of the partial current sources. This provides a kind of two level programming wherein the programmable main current source is used for a rough adjustment of the gray level curve and the programming of the partial current sources is used to fine-tune the behavior of the gray level voltage curves.

It advantageously proposed to implement a bias current generation circuit, which is generating a bias current depending on the voltage difference between maximum and minimum voltage. The bias current may be supplied to the main current source. If the difference between maximum and minimum voltage becomes smaller (bigger) also the bias current decreases (increases) resulting in a decreasing (increasing) main current. This kind of bias current generation is rather a calibration than a programming and is used for a very accurate calibration of the current to overcome process and circuit offsets and is done only once per circuit. Thus an automatically generation of the current is achieved.

The object of the present invention is also solved by a display applying such circuit arrangement as claimed in one the claims 1 to 9.

Since the most kinds of displays are using different gray level voltages the inventive circuit arrangement may be used independently of the kind of display.

The object of the present invention is also solved by a method for providing different gray level curves representing different voltage characteristics supplied to a display device comprising the steps of: selecting a maximum and a minimum voltage from the first voltage unit, amplifying a maximum and a minimum voltage, providing the amplified maximum and minimum voltages to a second voltage divider unit, injecting a current into tap points within the second voltage divider unit and providing different gray level voltages to the display.

Preferred embodiments of the invention are described in detail below by way of example only, with reference to the following schematic drawings.

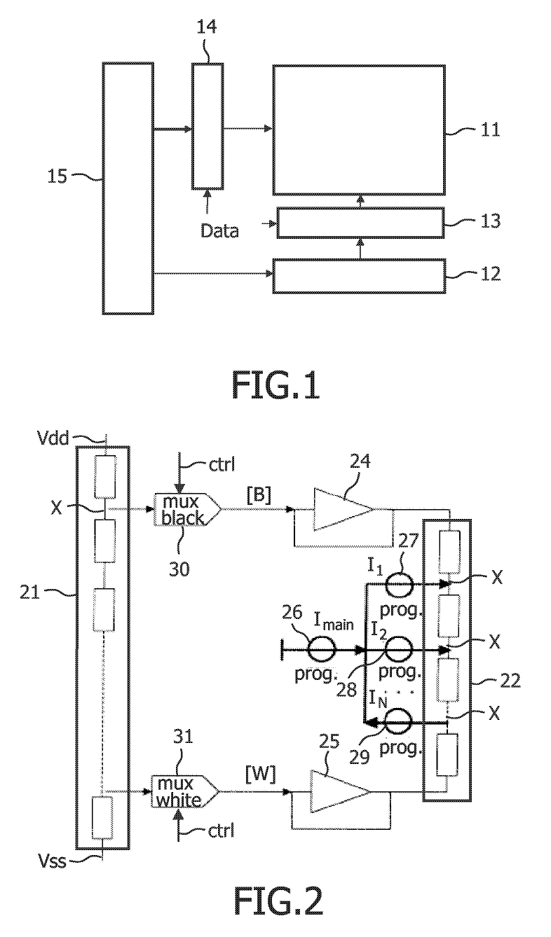

FIG. 1 illustrates a schematic diagram of a display device and a circuit arrangement according to the present invention;

FIG. 2 shows a detailed diagram of the circuit arrangement according to the present invention;

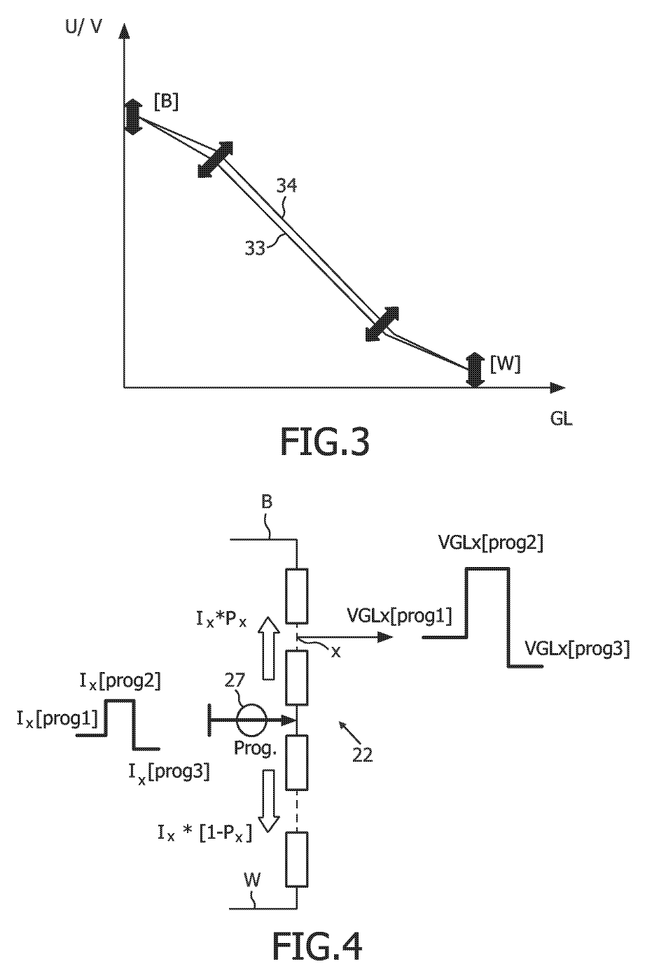

FIG. 3 illustrates a diagram of gray level curves adjustments according to the present invention;

FIG. 4 represents an illustration of the current injection into tap points of the second voltage divider unit according to the present invention;

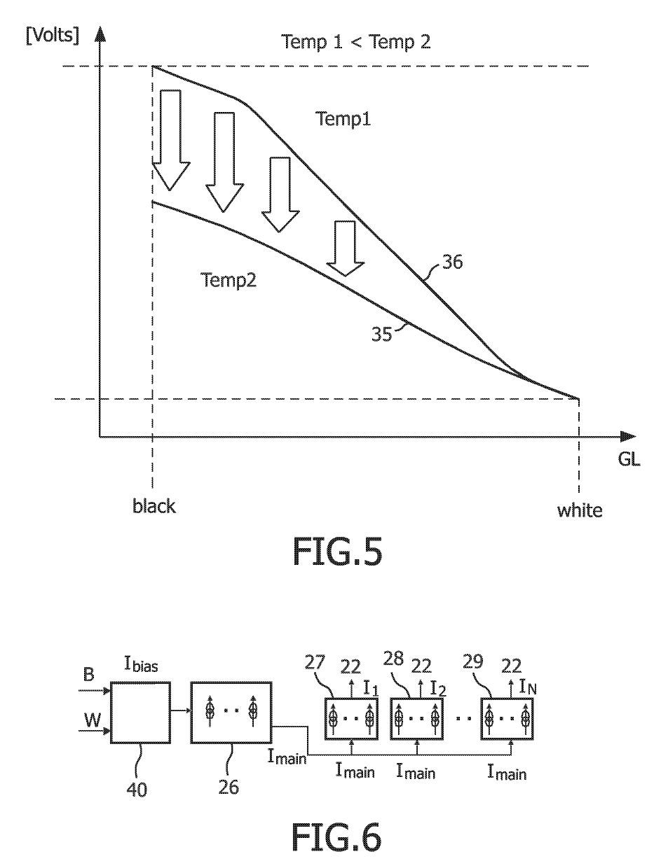

FIG. 5 represents a diagram representing the adjustment of gray level curves according to a temperature change;

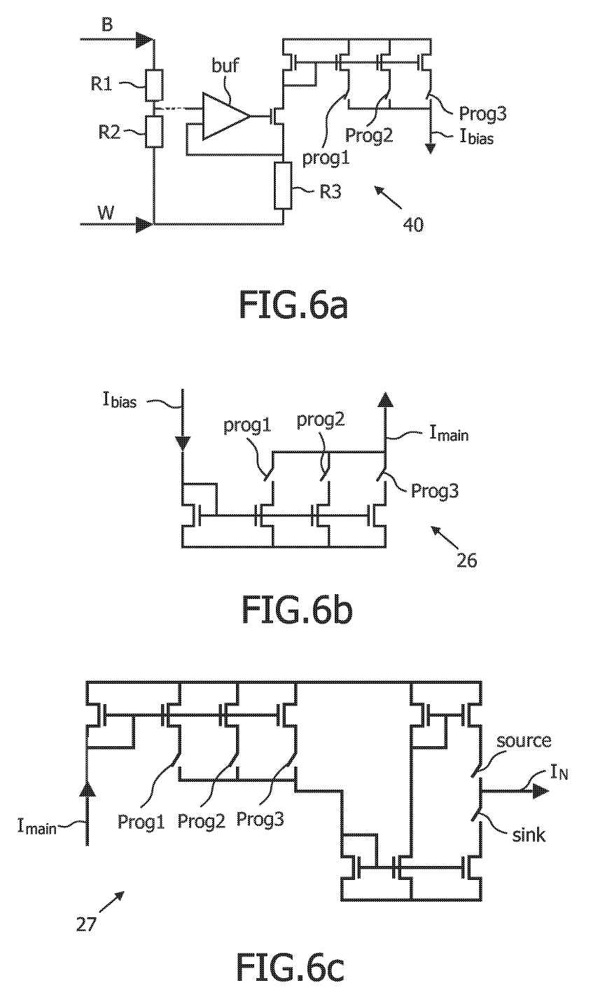

FIG. 6 represents a schematic path of the current supply chain according to the invention;

FIG. 6a shows an exemplary circuit used as bias current generation circuit according to the invention;

FIG. 6b shows an exemplary circuit used as main current source according to the invention;

FIG. 6c shows an exemplary circuit used as partial current source according to the invention;

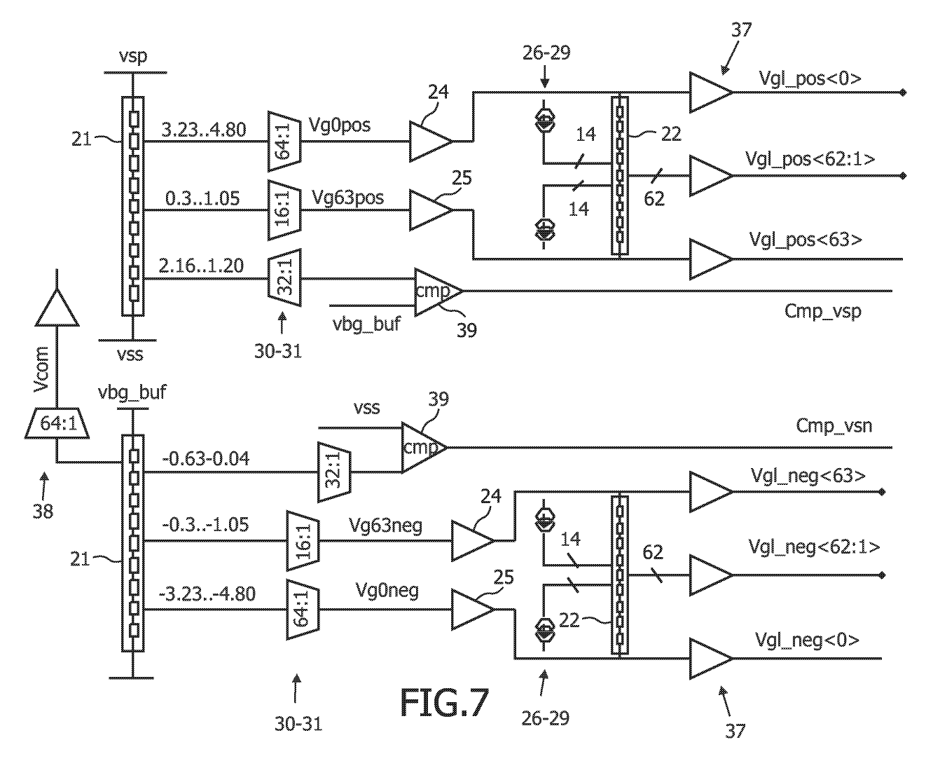

FIG. 7 shows a further embodiment of an exemplary gray level generation circuit, according to the invention;

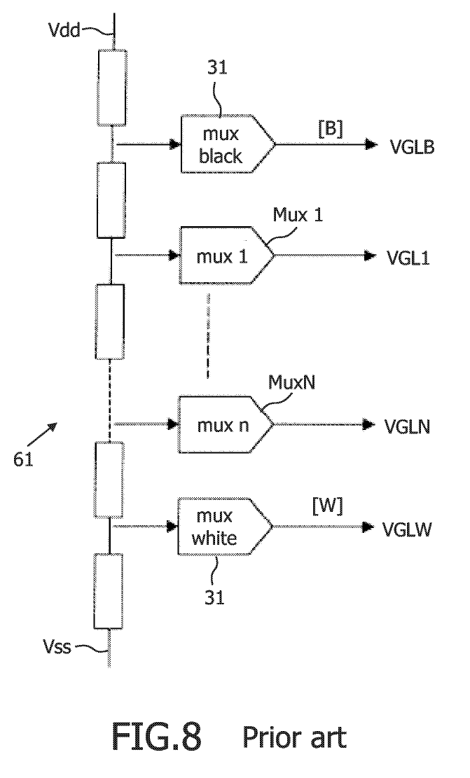

FIG. 8 shows a first voltage divider unit and a gray level curve providing unit according to the prior art.

The drawings are provided for illustrative purpose only and do not necessarily represent practicable examples of the present invention to scale.

In the following, the various exemplary embodiments of the invention are described. Although the present invention is applicable to a broad variety of applications it will be described with a focus put on liquid crystal display applications including active matrix displays and passive matrix display. A further field for applying the invention might be e.g. OLED, PLED or LTPS.

Before embodiments of the present inventions are described, some basics, in accordance with the present invention are addressed. The invention deals with providing gray level voltages to display devices.

Active matrix display devices use thin film transistors (TFT) arranged at a pixel of a display device. For representing a true color three different thin film transistors are arranged within each pixel. Depending on the switching state of each transistor a respective color will be shown.

For passive matrix displays, there is no switching device assigned to a pixel. The state of the liquid crystal at a certain pixel will be influence by the voltage across that pixel which is adjusted by the supplied voltages on the row electrode and the column electrode.

The invention will be described for the example of active matrix displays. Depending on the voltage level which is supplied to the electrodes of the display panel the thin film transistor will cause the liquid crystal to take a certain alignment. Depending on the alignment of the liquid crystal at that pixel the amount of reflected or passed light or the gray level is adjusted, which could be received or which recognized by a user.

A general diagram illustrating the construction of a display device 11 and a circuit arrangement according to the present invention is illustrated in FIG. 1. The display device 11 is supplied with voltages from the gate driving circuit 14 which activates the gates of the TFTs. The gray level voltage generation circuit 12 according to the present invention provides a plurality of gray level voltages to the gray level voltage selection circuit 13 which provides the gray level voltages to the electrodes of the display device. The gray level voltage selection circuit 13 selects the respective gray level voltage for the respective electrodes in dependency of the data supplied from not illustrated controlling and memory circuits. So depending on the data to be displayed the required voltages are selected and supplied. Both the gray level voltage generation circuit 12 and the gate driving circuit 14 are supplied with voltages from the system power supply generating circuit 15.

Referring to FIG. 2, a detailed diagram is shown representing the gray level voltage generation circuit according to the present invention 12. This circuit arrangement comprises a first voltage divider unit 21 and a second voltage divider unit 22. The first and second voltage divider unit are realized as resistor ladders. The resistor ladders 21 and 22 including a plurality of resistors which are coupled to each other in series. Between the respective resistors, there are tap points x used for providing a respective partial voltage. The first voltage divider unit 21 is coupled to a first and second voltage references which are a positive voltage Vdd and a common reference voltage Vss. Typically a positive and a negative gray level voltage curve is generated, thus also a negative voltage could be supplied the first voltage unit 21, as illustrated in FIG. 8. There are voltage selection units 31 and 30 which are provided between amplifying units 24 and 25 and the first resistor ladder 21. The amplifying units 24 and 25 are provided between the first and second resistor ladders 21 and 22 and in particular between the voltage selection units 30, 31 and the second voltage dividing unit 22. The first multiplexer 30 provides a first maximum voltage B used as voltage for representing the black color on the display panel. In contrary, the lowest minimum voltage supplied by the multiplexer 31 provides the voltage W used for representing the white color on the display device. By supplying a control signal ctrl to the multiplexers 30, 31 the level of the maximum and the minimum voltages B, W could be adjusted. It should be noted that on other displays the voltage value B could be the minimum and voltage value W the maximum voltage.

There are further programmable current sources 26 to 29. A main programmable current source 26 is adjusting the main current Iₘₐᵢₙ supplied to the second resistor ladder 22. In particular, the main current Iₘₐᵢₙ is provided to the plurality of partial programmable current sources 27, 28, 29. The partial programmable current sources 27 to 29 are injecting a respective current Iₓ to the tap points x within the second resistor ladder 22. As illustrated in FIG. 2 the current sources 27 and 28 are injecting or sourcing a current I₁, I₂ into the tap points x₁ and x₂ of the resistor ladder 22, wherein the programmable current source 29 is sinking a current I_{N} from the tap point x_{N} of the second resistor ladder 22. By programming the plurality of current sources 26-29, it is possible to shift or adjust the gray level curves as illustrated in FIG. 3. In general each current source 26-29 may be programmed to source or sink a current into a tap point x.

FIG. 3 represents two different gray level curves 33, 34 according to the present invention which are showing different characteristics wherein the current sources 26 to 29 are programmed differently so an adjustment of the voltage characteristics of the gray level curves 33, 34 is possible without using a different driving circuit arrangement. The possibilities of adjustment of the curves 33, 34 are indicated by the arrows. Due to the clarity it is omitted to illustrate the negative gray level voltage curve.

FIG. 4 illustrates a more detailed circuit diagram of the second voltage divider unit 22. Due to the clarity only one programmable current source 27 is shown therein. It is illustrated that depending on the programming prog1, prog2, prog3 the injected current Iₓ is changed. Since the voltage VLGₓ on the tap points x depends on the current Iₓ and the respective ohmic partitioning the resulting gray level voltages VGLₓ are also changed accordingly. It could be seen that if a current Iₓ according programming prog1 is injected the corresponding gray level voltage VLGₓ[prog1] will be changed also. The programming prog2 will cause a higher current Iₓ which is injected in the tap points x of the second resistor ladder 22 and which will cause a higher gray level voltage VLGₓ[prog2]. The programming prog3 of the current source 27 will sink a current Iₓ from the second resistor ladder 22 resulting in a decreased gray level voltage VLGₓ[prog3].

FIG. 5 represents a diagram showing the dependency of the gray level curves from the temperature. The temperature Temp1 is smaller than the temperature Temp2. Since there is a strong temperature dependency of the display panels, it is necessary to adapt the gray level voltage curves to the different temperatures. By adjusting the maximum voltage B representing the black color using the voltage selection multiplexer 30 it is possible to shift the gray level curve 36 to the gray level curve 35 without adjusting and programming all current sources. Only the main current source 26 needs to be reprogrammed to adapt the gray level curve to the Temp2. The current is now adapted automatically on a change of minimum and/or maximum voltages B, W.

The same could be achieved by adjusting the minimum voltage W used for representing the white color. This behavior is not illustrated wherein this will change the characteristics in respect to the minimum voltage W used for the white color representation.

FIG. 6 shows a schematic path of generation or providing the various current according to the present invention. At first there is a bias current generation circuit 40 provided for controlling the bias current I_{bias}. The controlled bias current I_{bias} is provided to the main current source 26. According to the programming of the main current source 26 the main current Iₘₐᵢₙ is provided. This main current Iₘₐᵢₙ is supplied to the plurality of partial current sources 27-29.

Referring to FIG. 6a, a realization of a bias current generation circuit 40 is presented. The bias current generation circuit 40 is generating the bias current I_{bias} depending on the voltage difference between the maximum and the minimum voltage B and W. If voltage difference between the maximum and the minimum voltage B and W changes also the bias current I_{bias} changes accordingly. In this bias current generation circuit 40 the bias current I_{bias} can also be programmed, but it's not necessary. This is rather a calibration than a programming and is used for a very accurate calibration of the current to overcome process and circuit offsets and is done only once per circuit. The resistors R1, R2 between B and W are used as voltage dividers to supply the appropriate voltage to the buffer buf. The buffer buf regulates the transistor on-resistance. By regulating the resistance of the transistor in the on-state the voltage drop over the third resistor R3 according to the voltage divider is controlled resulting in a controlled bias current I_{bias}.

FIG. 6b shows a realization of a main current source 26. Depending on the states of the switches Prog1-Prog3 the main current Iₘₐᵢₙ is adapted. This main current Iₘₐᵢₙ is supplied to the partial current sources 27-29 as shown in FIG. 6c. The current source presented in FIG. 6c includes the same components as the current source in FIG. 6b, further two switches “sink” and “source” are provided to adjust if the current I_{N} is sunk or sourced into the respective tap point x.

As there is a positive and negative gray level curve two independent bias currents I_{bias} are needed. A usual bias generation circuit may be used to supply them, but then the temperature compensation of the Iₘₐᵢₙ must be programmed as known from the prior art. By using the inventive automatically adaptation of the currents the temperature compensation of the main current Iₘₐᵢₙ is performed by the bias current generation circuit 40.

FIG. 7 illustrates a further embodiment of a gray level voltage generation circuit 12 according to the present invention. Generally the same architecture as in FIG. 2 is used. However by using such architecture a positive and a negative gray level curve could be provided. The upper part is used for generating a positive gray level voltage curve VGL_pos0, VGL_pos<1-62>, VGL_pos63 based on the positive voltages vsp and the reference voltage vss. Further buffers 37 are used to stabilize the generated gray level voltages. The components 38 and 39 are used to provide further reference voltages or control signals used within the circuitry. The lower part of the circuitry is used for generating the negative gray level voltage curve VGL_neg0, VGL_neg<1-62>, VGL_neg63 based on the reference voltage vbg-buf and the negative voltage vsn. By using voltage selection units or multiplexers 30 and 31 in each part, the respective maximum and minimum voltages are adjusted.

By adapting the number N of the current sources 26-29 and their tap positions, the required accuracy of the gray level voltage curves and values may be adjusted. Since the voltage follows a linear relationship, as soon as the maximum and minimum voltages B, W and a current I from each current source 26 to 29 are known, all gray level voltage values VLGₓ could be found. Any gray level voltage VGLₓ corresponding to a tap point x for the current sources 26 to 29 in the resistor ladder 22 is given by Equation 1, wherein

$${VGL}_{x} = ( \frac{[ B ] - [ W ]}{{R}_{tot}} + {\sum }_{1}^{N} {I}_{x} {P}_{x} - {\sum }_{1}^{N} {I}_{x} ( 1 - {P}_{x} ) ) * {R}_{x}$$

wherein Rₜₒₜ is the resistor value of the second resistor ladder 22, Iₓ is any single programmed current (injected or sunk) from a tap point x, wherein Pₓ is the ohmic partitioning seen at the tap point x. Rₓ is the resistor value at the tap point x.

The critical design aspect is the current programming. To generate a specific gray level voltage curve, at first the main current Iₘₐᵢₙ is programmed with a minimum current stepping. Then this current Iₘₐᵢₙ is delivered to the N programmed current sources 27 to 29 which mirror it according to the target gray level voltage curve. The injected/sunk current Iₓ at a tap point x is then given by equation 2

Iₓ=Iₘₐᵢₙ*progIₘₐᵢₙ*progIₓ

where progIₘₐᵢₙ and progIx are respectively the bit programming for the main current Iₘₐᵢₙ and for the single current sources 27 to 29 at their tap point x.

This two-level programming (gross for Iₘₐᵢₙ and fine for Iₓ) allows a finer resolution of the gray level voltage curve.

There is a particular advantage in case of temperature compensation. If the black value B must be reduced as shown in FIG. 5 this will be done easily by the multiplexer 30 attached to the first resistor ladder 21. To maintain the monotony of the gray level voltage curves 35 only the main current Iₘₐᵢₙ must be reduced without changing the programming of the partial current sources 27 to 29, which is reduced automatically. The current reduction factor follows the equation 3 and refers respectively to the main current Iₘₐᵢₙ and to the voltage difference between black B and white W value at the two temperatures Temp1 and Temp2.

$${I}_{main} = [ @ Temp 2 ] = {I}_{main} [ @ Temp 1 ] * \frac{Δ [ BW ] @ Temp 2}{Δ [ BW ] @ Temp 1}$$

$$for$$

$$Temp 2 > Temp 1$$

In particular, care should be taken on the design of the programmable current sources 26 to 29 in order to minimize current errors due to temperature and process issues which will cause errors in the gray level curves. A cascading architecture and earlier out mentioned techniques should be always adapted.

FIG. 8 represents a known gray level voltage generation circuit. A first resistor ladder 61 includes a couple of voltage selection units 30, 31, Mux1 to MuxN. By controlling and adjusting the several multiplexers 30, 31, Mux1 to MuxN it is possible to adapt the gray level voltage curves, wherein the effort for providing such plurality of multiplexers 30, 31, Mux1 to MuxN is dramatically higher that the arrangement of current sources 26-29 as proposed according to the present invention.

By using the inventive circuit arrangement it is possible to easily adapt the gray level curve depending on the used display device and other conditions. So only one circuit arrangement including the inventive circuit is necessary to be used for a plurality of display devices.

These embodiments have been described in an illustrative manner, and it is to be understood that the terminology which has been used is intended to be in the nature of words of description rather than of limitation. It is further to be understood that the terminology “comprising” does not exclude other elements or steps. One skilled in the art will readily recognize from such discussion, and from the accompanying drawings and claims, that changes and modifications can be made without departing from the scope of the invention as defined in the following claims, wherein reference signs shall not be construed as limiting the scope of claims.

1. Circuit arrangement for providing voltages for generation of different gray levels in a display device, the circuit arrangement including: a first voltage unit; a second voltage divider unit having a plurality of tap points; at least one amplifying unit coupled between the first voltage unit and the second voltage divider unit, wherein at least one programmable current source is provided for injecting a current into a tap point of the second voltage divider unit.

2. Circuit arrangement as claimed in claim 1, wherein the first voltage unit is providing at least one reference voltage to the at least one amplifying unit.

3. Circuit arrangement as claimed in claim 1, wherein the first voltage unit is realized as voltage divider unit and/or the first and second voltage divider units are realized as resistor ladders.

4. Circuit arrangement as claimed in claim 1, wherein at least one voltage selecting unit is coupled to the first voltage divider unit for adjusting a maximum voltage or a minimum voltage supplied to the second voltage divider unit.

5. Circuit arrangement as claimed in claim 1, wherein a first voltage selecting unit is coupled between the first voltage divider unit and the second voltage divider unit for providing the maximum voltage and a second voltage selecting unit is coupled between the first and the second voltage divider unit for providing then minimum voltage.

6. Circuit arrangement as claimed in claim 5, wherein the selected maximum voltage and minimum voltage is supplied each to a amplifying unit for amplifying the selected minimum and maximum voltage.

7. Circuit arrangement as claimed in claim 1, wherein a programmable main current source and at least one programmable partial current source are provided, the main current source is adjusted to supply a main current to the at least one partial current source coupled to a tap point within the second voltage divider unit.

8. Circuit arrangement as claimed in claim 7, wherein a plurality of programmable partial current sources are provided, each coupled to a tap point within the second voltage divider unit for injecting or sinking a current.

9. Circuit arrangement as claimed in claim 1, wherein a bias current generation circuit is coupled to the main current source to provide a bias current depending on the voltage difference between the maximum and the minimum voltage.

10. Display device applying a circuit arrangement as claimed in claim 1.

11. Method for providing different gray level curves representing different voltages characteristics supplied to a display device, comprising the steps of: selecting a maximum and a minimum voltage from a first voltage unit; amplifying the maximum and a minimum voltage; providing the amplified maximum and minimum voltages to a second voltage divider unit; injecting a current into tap points within the second voltage divider unit.
